(19) United States
(12) Patent Application Publication
(10) Pub. No.: US 2003/0026578 A1
(43) Pub. Date: Feb. 6, 2003

(54) Optical components having a reduced stress

(76) Inventors: Chi Wu, San Marino, CA (US); Dawei Zheng, Los Angeles, CA (US)

Correspondence Address: Travis Dodd, 2490 Heyneman Hollow, Fallbrook, CA, 92028, US

(21) Appl. No.: 09/922,502

(22) Filed: Aug. 3, 2001

(51) Int. Cl. G02B 6/10

(52) U.S. Cl. 385/132; 385/129

(57) ABSTRACT

A method of forming an optical component is disclosed. The method includes forming a primary base on an optical component precursor having a light transmitting medium positioned adjacent to a preliminary base. The coefficient of thermal expansion (CTE) of the primary base is closer to the CTE of the light transmitting medium than the CTE of the preliminary base is to the CTE of the light transmitting medium. The method also includes removing at least a portion of the preliminary base.

### RELATED APPLICATIONS

This application is related to U.S. patent application Ser. No. 09/723,764, filed on Nov. 28, 2000, entitled “Silica Waveguide”; U.S. patent application Ser. No. 09/784,636, filed on Feb. 15, 2001, entitled “Component Having a Reduced Thermal Sensitivity”; U.S. patent application Ser. No. 09/784,814, filed on Feb. 15, 2001, entitled “Component Having Reduced Cross Talk”; U.S. patent application Ser. No. 09/821,822, filed on Mar. 29, 2001, entitled “Waveguide Having Light Barrier that Serves as Alignment Groove”; U.S. patent application Ser. No. 09/724,173, filed on Nov. 28, 2000, entitled “Demultiplexer Having a Compact Light Distributor”; and Provisional Patent application serial No. 60/239,534, filed on Oct. 10, 2000, entitled “A Compact Integrated Optics Based Arrayed Waveguide Demultiplexer.” Each of the above related applications are incorporated herein in its entirety.

### BACKGROUND

1. Field of the Invention

The invention relates to one or more optical components. In particular, the invention relates to components having a light transmitting medium formed over a base.

2. Background of the Invention

Optical networks employ a variety of optical components for processing of light signals. These optical components are often formed from an optical component precursor that includes a light transmitting medium positioned over a base. Forming the optical component from the optical component precursor often includes defining one or more waveguides in the light transmitting medium.

The light transmitting medium is often formed on the base by growing the light transmitting on the base or by bonding the light transmitting medium to the base. Elevated temperatures are often employed when growing the light transmitting on the base or by bonding the light transmitting medium to the base. The component precursor is cooled to room temperature after forming the light transmitting medium on the base.

The base and the light transmitting medium often have different coefficients of thermal expansion. The different coefficients of thermal expansion cause the component precursor to warp as the component precursor is cooled from the elevated temperatures. This warping can place a stress on the light transmitting medium and can accordingly change the index of refraction of the light transmitting medium. As a result, the warping can affect the performance of waveguides defined in the light transmitting medium.

As a result, there is a need for an optical component that is associated with a reduced level of warping.

### SUMMARY OF THE INVENTION

The invention relates to a method of forming an optical component. The method includes forming a primary base on an optical component precursor having a light transmitting medium positioned adjacent to a preliminary base and removing at least a portion of the preliminary base. The coefficient of thermal expansion (CTE) of the primary base is closer to the CTE of the light transmitting medium than the CTE of the preliminary base is to the CTE of the light transmitting medium.

The method can include cooling the component precursor after or during the formation of the primary base on the component precursor. In some instances, the component precursor is cooled at a rate slower than 180° C./hour, 150° C./hour, 120° C./hour, 90° C./hour or 60° C./hour. The component precursor can be cooled over a temperature range of at least 120° C., 200° C., 400° C., 500° C. or 600° C.

In some instances, the method includes heating the component precursor after forming the primary base on the component precursor and before cooling the component precursor. The component precursor can be heated to a temperature greater than 100° C., 150° C., 200° C., 300° C., 500° C., 700° C., 900° C. or 1100° C.

The method can also include defining one or more waveguides in the light transmitting medium. In some instances, the primary base includes one or more pockets and the waveguides are defined by forming ridges over the one or more pockets.

The invention also relates to a component precursor for formation of an optical component. The component precursor includes a light transmitting medium positioned between a primary base and a preliminary base. A coefficient of thermal expansion (CTE) of the primary base is within a range of the CTE of the light transmitting medium plus or minus three times the CTE of the light transmitting medium.

Suitable materials for the primary base include, but are not limited to, borosilicate glass, fused quartz and fused silica.

The CTE of the primary base can be within a range of the CTE of the light transmitting medium +/−2 times the CTE of the light transmitting medium; the CTE of the light transmitting medium +/− the CTE of the light transmitting medium; the CTE of the light transmitting medium +/−0.7 times the CTE of the light transmitting medium; the CTE of the light transmitting medium +/−0.5 times the CTE of the light transmitting medium; the CTE of the light transmitting medium +/−0.25 times the CTE of the light transmitting medium; or the CTE of the light transmitting medium +/−0.1 times the CTE of the light transmitting medium.

The CTE of the preliminary base can be outside of a range of the CTE of the light transmitting medium +/−3 times the CTE of the light transmitting medium; the CTE of the light transmitting medium +/−2.5 times the CTE of the light transmitting medium; the CTE of the light transmitting medium +/−2 times the CTE of the light transmitting medium; the CTE of the light transmitting medium +/−1.5 times the CTE of the light transmitting medium; the CTE of the light transmitting medium +/− the CTE of the light transmitting medium; the CTE of the light transmitting medium +/−0.5 times the CTE of the light transmitting medium.

In some instances the difference in the CTE of the preliminary base and the light transmitting medium is greater than the difference in the CTE of the primary base and the light transmitting medium and the CTE of the primary base is within 1.5 ppm/° C. of the CTE of the light transmitting medium; 1.0 ppm/° C. of the CTE of the light transmitting medium; 0.5 ppm/° C. of the CTE of the light transmitting medium; 0.35 ppm/° C. of the CTE of the light transmitting medium; 0.2 ppm/° C. of the CTE of the light transmitting medium or 0.06 ppm/° C. of the CTE of the light transmitting medium.

### BRIEF DESCRIPTION OF THE FIGURES

FIG. 1A is a topview of a portion of an optical component having a waveguide.

FIG. 1B is a cross section of the portion of the optical component illustrated in FIG. 1A taken at the line labeled A.

FIG. 2 illustrates an optical component having a primary base with a composite construction.

FIG. 3A through FIG. 3E illustrate a method of forming an optical component precursor suitable for fabricating the optical components such as the optical components illustrated in FIG. 1A through FIG. 2.

### DETAILED DESCRIPTION OF THE PREFERRED EMBODIMENT

The invention relates to a method of forming an optical component. The method includes obtaining an optical component precursor from which the optical component will be fabricated. The optical component precursor can be fabricated or can be received from a supplier. The optical component precursor includes a light transmitting medium positioned over a preliminary base. The preliminary base serves as a support for the light transmitting medium. Accordingly, a suitable preliminary bases may include a substrate or wafer. The component precursor is often under stress that results from the fabrication process.

In some instances, a primary base is formed on the component precursor and the preliminary base is entirely removed. In these instances, the primary base is substituted for the preliminary base. The primary base also serves as support for the light transmitting medium. As a result, a suitable primary support may include a wafer or a substrate. The coefficient of thermal expansion (CTE) for the primary base is closer to the CTE of the light transmitting medium than the CTE of the preliminary base is to the CTE of the light transmitting medium.

After the removal of the base, the component precursor can be heated and cooled to room temperature. When the temperature of the component precursor is elevated, the molecules in the light transmitting medium and the primary base move more freely. As a result, the stress between the light transmitting medium and the primary base can relax at the elevated temperature. The component precursor is then reduced to room temperature. The amount of stress placed on the component precursor as a result of cooling falls as the coefficient of thermal expansion (CTE) of the primary base approaches the CTE of the light transmitting medium. When the primary base is substituted for the preliminary base, the amount of stress placed on the component precursor as a result of cooling is reduced because the CTE of the primary base is closer to the CTE of the light transmitting medium than the CTE of the preliminary base is to the CTE of the light transmitting medium.

The method also allows for the fabrication of component precursors without a crystalline base. Many component precursors are fabricated by growing a light transmitting medium on a base. Light transmitting media such as silica require a crystalline base for growth in order to achieve a desirable optical quality. As a result, a crystalline preliminary base is often required in prior component precursors. However, the method allows a non-crystalline primary base to be substituted for a crystalline preliminary base. As a result, the present invention expands the range of materials that can be employed in conjunction with optical component precursors.

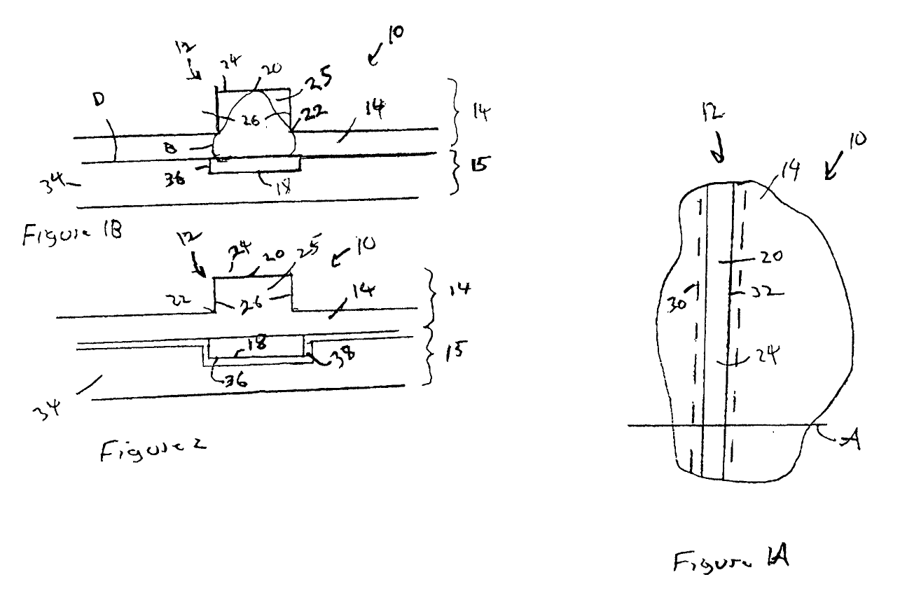

FIG. 1A is a topview of a portion of an optical component having a waveguide. FIG. 1B is a cross section of the portion of the optical component 10 illustrated in FIG. 1A taken at the line labeled A. The optical component 10 includes a light transmitting medium 14 on a primary base 15. Suitable light transmitting media include, but are not limited to, silicon and silica. The primary base 15 includes one or more surfaces 36 that define a pocket 18. The light transmitting medium 14 includes a ridge 32 having a base 22, a top 24 and opposing sides 26. The ridge defines a portion of a light signal carrying region 25. The profile of a light signal being carried in the light signal carrying region is illustrated by the line labeled B.

The pocket 18 can hold a material that reflects light signals from the light signal carrying region back into the light signal carrying region. For instance, the pocket 18 can hold a gas such as air or another medium with an index of refraction that is less than the index of refraction of silica. The drop in the index of refraction causes reflection of the light signals that are incident on the material in the pocket 18. Accordingly, the material in the pocket 18 restrains the light signals to the light signal carrying region.

FIG. 1A shows the periphery of the pocket 30 relative to the periphery of the ridge 32. The periphery of the pocket 30 is illustrated as a dashed line. The ridge is positioned over the pocket 18 and the periphery of the pocket 30 traces the periphery of the ridge 32. For instance, the distance between the ridge base 22 and the periphery of the pocket 30 can be substantially constant along the length of at least a portion of the waveguide.

The pocket 18 and the ridge 32 can be constructed such that the periphery of the pocket 30 extends beyond the periphery of the ridge 32. In some instances, the pocket 18 and waveguide 12 are constructed such that the periphery of the pocket 30 is substantially the same size as the periphery of the ridge 32. In other instances, the pocket 18 and the ridge are constructed such that the periphery of the pocket 30 is smaller than the periphery of the ridge 32.

In some instances, the width of the pocket 18 is larger than 200% of the width of the ridge base 22. In other instances, the width of the pocket 18 is less than 200% of the ridge base 22 width, less than 150% of the ridge base 22 width, less than 140% of the ridge base 22 width, less than 130% of the ridge base 22 width, less than 120% of the ridge base 22 width, less than 110% of the ridge base 22 width, less than 100% of the ridge base 22 width. When a pocket 18 is employed with another type of waveguide, the pocket 18 can have the same dimensional relationships to the width of the waveguide 12 that is employed with respect to the ridge.

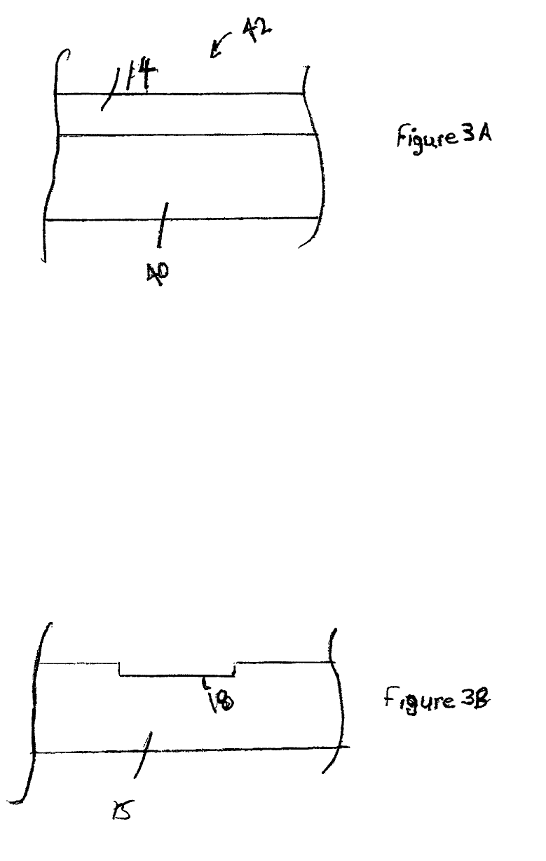

The primary base 15 can include a substrate 34 such as a silicon substrate 34. As shown in FIG. 1A, the substrate 34 can have one or more surfaces 36 that define a pocket 18 in the substrate 34. Alternatively, the base can have a composite construction. For instance, one or more layers of material can be formed over the substrate as shown in FIG. 2. Suitable layers of material include, but are not limited to, silica.

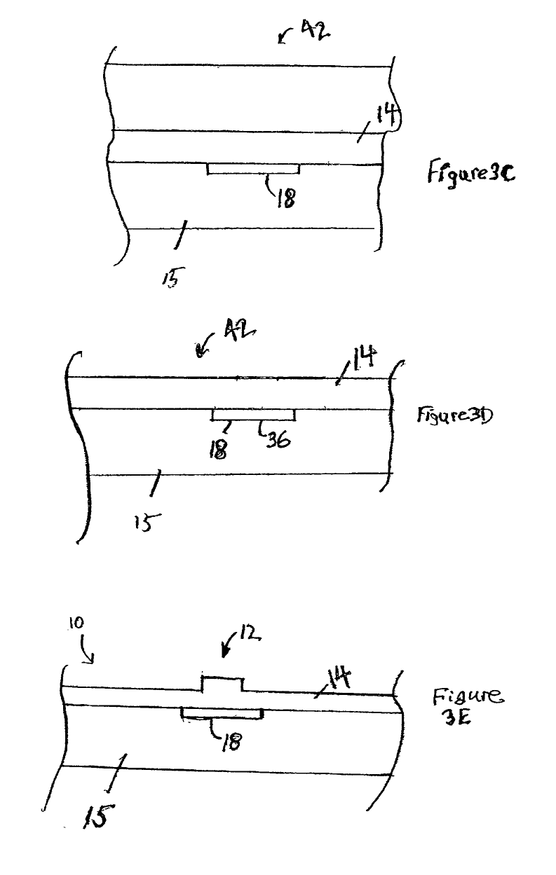

FIG. 3A through FIG. 3E illustrate a method of forming an optical component 10. FIG. 3A illustrates an optical component precursor 42 having a light transmitting medium 14 positioned on a preliminary base 40. A suitable preliminary base 40 provides support to the light transmitting medium 14. Examples include wafers and substrates. A suitable thickness for the preliminary base includes, but is not limited to, a thickness greater than 20 μm, 50 μm, 100 μm, 200 μm, 300, μm, 400 μm or 675 μm.

The light transmitting medium 14 can be formed on the preliminary base 40 by growing or depositing the light transmitting medium 14 on the preliminary base 40. Growing or depositing of the light transmitting medium 14 is generally performed at elevated temperatures that can exceed 1000° C. Alternatively, the light transmitting medium 14 can also be formed on the preliminary base 40 by employing wafer bonding to bond a wafer that includes the light transmitting medium 14 to the base. When the bonded wafer includes layers other than the light transmitting medium 14, these layers can be removed using techniques such as etching, polishing or buffing. Wafer bonding techniques can employ elevated temperatures in order to strengthen the bonding that occurs. As a result, formation of the component precursor 42 illustrated in FIG. 3A is generally associated with elevated temperatures.

During or after formation of the light transmitting medium 14 on the preliminary base 40, the component precursor 42 is cooled down to room temperatures from the elevated temperatures. As noted above, the light transmitting medium 14 and the base often have different coefficients of thermal expansion. The different coefficients of thermal expansion cause the light transmitting medium 14 to experience stress during the cool down phase.

FIG. 3B illustrates a primary base 15. A suitable thickness for a primary base includes, but is not limited to, a thickness greater than a thickness greater than 20 μm, 50 μm, 100 μm, 200 μm, 300, μm, 400 μm or 675 μm. The primary base 15 includes one or more pockets 18. The one or more pockets 18 can be formed in the primary base 15 by masking and etching the primary base 15. When the light transmitting medium 14 is silica, a suitable material for the primary base 15 includes, but is not limited to, borosilicate glass, fused silica and fused quartz. The pockets 18 are optional as some optical component 10 constructions do not require pockets 18 formed in the base.

The primary base 15 is bonded to the component precursor 42 as illustrated in FIG. 3C. In the illustrated embodiment, the primary base 15 is bonded to the component precursor 42 such that the light transmitting medium 14 is positioned between the preliminary base 40 and the primary base 15. Suitable methods for bonding the light transmitting medium 14 to the primary base 15 include, but are not limited to, wafer bonding techniques. As noted above, wafer bonding techniques can employ elevated temperatures. As an alternative to wafer bonding techniques, the primary base 15 can be grown or deposited on the component precursor 42. Growing or depositing the primary base 15 on the component precursor 42 can also employ elevated temperatures. As a result, in some instances, the component precursor 42 is cooled to room temperature during or after formation of the primary base 15 on the component precursor 42.

The CTE of the primary base 15 can be within a range of the CTE of the light transmitting medium +/−3 times the CTE of the light transmitting medium 14; the CTE of the light transmitting medium +/−2.5 times the CTE of the light transmitting medium 14; the CTE of the light transmitting medium +/−2 times the CTE of the light transmitting medium 14; the CTE of the light transmitting medium +/−1.5 times the CTE of the light transmitting medium 14; the CTE of the light transmitting medium +/− the CTE of the light transmitting medium 14; the CTE of the light transmitting medium +/−0.5 times the CTE of the light transmitting medium 14; or the CTE of the light transmitting medium +/−0.25 times the CTE of the light transmitting medium 14 while the CTE of the preliminary base 40 is outside of a range of the CTE of the light transmitting medium +/−3 times the CTE of the light transmitting medium 14; the CTE of the light transmitting medium +/−2.5 times the CTE of the light transmitting medium 14; the CTE of the light transmitting medium +/−2 times the CTE of the light transmitting medium 14; the CTE of the light transmitting medium +/−1.5 times the CTE of the light transmitting medium 14; the CTE of the light transmitting medium +/− the CTE of the light transmitting medium 14; the CTE of the light transmitting medium +/−0.5 times the CTE of the light transmitting medium 14.

In some instances the difference in the CTE of the preliminary base 40 and the light transmitting medium 14 is greater than the difference in the CTE of the primary base 15 and the light transmitting medium 14 and the CTE of the primary base 15 is within 1.5 ppm/° C. of the CTE of the light transmitting medium 14; 1.0 ppm/° C. of the CTE of the light transmitting medium 14; 0.5 ppm/° C. of the CTE of the light transmitting medium 14; 0.35 ppm/° C. of the CTE of the light transmitting medium 14; or 0.2 ppm/° C. of the CTE of the light transmitting medium 14.

A component precursor 42 having a preliminary base 40 constructed of silicon and a light transmitting medium 14 of silica provides an example of a component precursor 42 where a primary base 15 can be employed to reduce the difference in the CTE of the light transmitting medium 14 and the base. The CTE of silica is about 0.5 ppm/° C., the CTE of silicon is about 2.3 ppm/° C., fused silica is commercially available with a range of CTE values including a CTE of about 0.55 ppm/° C. and fused quartz is commercially available with a range of CTE values including a CTE of about 0.55 ppm/° C. When the light transmitting medium 14 is constructed of silica and the preliminary base 40 is constructed of silicon, the difference in CTE of the light transmitting medium 14 and the preliminary base 40 is about 1.8 ppm/° C. However, when the primary base 15 is constructed of fused silica, the difference in the CTE of the light transmitting medium 14 and the primary base 15 can be about 0.05 ppm/° C. When the primary base 15 is constructed of fused quartz, the difference in the CTE of the light transmitting medium 14 and the primary base 15 can be about 0.05 ppm/° C.

The preliminary base 40 is removed and the component precursor 42 is inverted to provide the component precursor 42 illustrated in FIG. 3D. Suitable methods for removing the base include, but are not limited to, etching, buffing, polishing, lapping, detachment through H implantation and subsequent annealing.

After the removal of the base, the component precursor 42 is subjected to a temperature treatment configured to reduce the stress on the component precursor 42. For instance, the component precursor 42 can be heated followed by cooling. In some instances, the component precursor is heated to above 100° C., 150° C., 200° C., 300° C., 500° C., 700° C., 900° C. or 1100° C. Heating of the component precursor 42 can reduce the stress on the component precursor 42. When the temperature is elevated, the molecules in the light transmitting medium 14 and the primary base 15 move more freely. As a result, the stress between the light transmitting medium 14 and the primary base 15 can relax more quickly at high temperatures than at low temperatures. Accordingly, the component precursor 42 is heated to a temperature where the stress on the component precursor 42 falls over a period of time that is suitable for production of component precursors 42.

When the temperature of the component precursor is elevated during or after formation of the primary base on the component precursor, the component precursor 42 can be cooled to room temperature. The amount of stress placed on the component precursor 42 as a result of cooling falls as the coefficient of thermal expansion (CTE) of the primary base 15 approaches the CTE of the light transmitting medium 14. Accordingly, when the coefficient of thermal expansion (CTE) of the primary base 15 is closer to the CTE of the light transmitting medium 14 than the CTE of the preliminary base 40, the amount of stress placed on the component precursor 42 is reduced when the component precursor 42 is cooled with the primary base 15 substituted for the preliminary base 40.

The stress placed on the light transmitting medium 14 as a result of cooling can be further reduced by including one or more slow cooling phases during the cooling of the component precursor 42. Because relaxation occurs more slowly at reduced temperatures, the slow cooling phase increases the opportunity for the component precursor 42 to relax as the component precursor 42 is cooled.

Suitable cooling rates for the slow cooling phases include, but are not limited to, cooling rates less than 3.0° C./min, 2.5° C./min, 2.0° C./min, 1.5° C./min, or 1.0° C./min. The cooling rates can be achieved continuously or by proceeding through a series of phases where the temperature of the component precursor 42 is held substantially constant. Suitable temperature ranges for the slow cooling phase include, but are not limited to, a range of at least 120° C., 200° C., 400° C., 500° C. or 600° C. The slow cooling phase can be started at temperatures greater than 100° C., 150° C., 200° C., 300° C., 500° C., 700° C., 900° C. or 1100° C. In some instances, the slow cooling phase is stopped at temperatures les than 700° C., 600° C. or 500° C.

When the light transmitting medium 14 is silica and the primary base 15 is fused silica, a suitable temperature treatment includes, but is not limited to, heating the component precursor 42 from room temperature to 800° C. at a rate of about 5° C./min; then from 800° C. to 1100° C. at a rate of about 5° C./min; maintaining the temperature of the component precursor 42 at 1000° C. for about 12 hours and cooling the component precursor 42 from 800° C. to 1100° C. at a rate of about 2° C./min. The above temperature treatment is only an example of a suitable temperature treatment and the temperature treatment should be optimized for the dimensions and materials of the optical component precursor.

A waveguide 12 can be defined in the light transmitting medium 14 as shown in FIG. 3E. The waveguide 12 can be defined by masking and etching the ridge 32 associated with one or more waveguides 12 in the light transmitting medium 14. The illustrated ridge 32 is formed over a pocket 18. Accordingly, when the one or more pockets 18 are formed in the primary base 15, the one or more pockets 18 are formed so as to be positioned under the locations where the ridges 32 will be formed once the primary base 15 is formed on the component precursor. Although the waveguide 12 formation is discussed after the temperature treatment, the waveguide(s) 12 can be defined in the light transmitting medium 14 before the temperature treatment.

The various temperature manipulations discussed with respect to FIG. 3A through FIG. 3E can be combined. For instance, the above method discloses forming the primary base 15 on the component precursor 42 after the component precursor 42 is cooled from the elevated temperatures employed during formation of the light transmitting medium 14 on the preliminary base 40. However, the primary base 15 can also be formed on the component precursor 42 without cooling the component precursor 42 to room temperature after formation of the light transmitting medium 14 on the preliminary base 40. The bonding of the primary base 15 to the component precursor 42 can occur while the temperature is being elevated, during the temperature peak or during the cooling down process. Further, the temperature versus time profile to which the component precursor 42 is subjected can have more than one peak and/or one or more minimums without reaching room temperature.

The above method describes removal of the preliminary base 40 after cooling of the component precursor 42 to room temperature. However, the base can be at least partially removed before the component precursor 42 is cooled to room temperature. As a result, the base can be removed at the elevated temperature employed during the formation of the primary base 15 on the component precursor 42. The temperature versus time profile to which the component precursor 42 is subjected can have more than one peak and/or one or more minimums without reaching room temperature.

In some instances, the primary base 15 can be formed on the component precursor 42 and the preliminary base 40 can be at least partially removed without cooling the component precursor 42 to room temperature after formation of the light transmitting medium 14 on the preliminary base 40. Further, the temperature treatment can also be performed without cooling the component precursor 42 to room temperature. For instance, if the preliminary base 40 is removed at an elevated temperature, the temperature of the component precursor 42 can be further elevated and then cooled with one or more slow cooling phases. Alternatively, the further temperature elevation can be eliminated. The temperature versus time profile to which the component precursor 42 is subjected can have more than one peak and/or one or more minimums without reaching room temperature.

In the method of FIG. 3A through FIG. 3E, the primary base 15 is shown as constructed from a single material, however, the primary base 15 can have a composite construction as discussed with respect to FIG. 2. The primary base 15 can be provided with a composite construction by growing or depositing one or more materials on the primary base 15 illustrated in FIG. 3B. The one or more materials can be positioned over the entire primary base 15. Alternatively, the one or more materials can be limited to particular locations on the primary base 15. For instance, masking techniques can be employed to limit the additional materials to being located in a pocket(s) 18 or outside of a pocket(s) 18.

Although not illustrated, the preliminary base 40 can also be provided with a composite construction. For instance, the preliminary base 40 can include a first material that is easily removed. The first material can be coated with a second material. The second material can be selected for the ease with which the light transmitting medium 14 can be grown or deposited on the second material.

When the primary base 15 and/or the preliminary base 40 has a composite construction, the CTE for the primary base 15 and/or the preliminary base 40 is a function of the various materials included in the primary base 15 as well as the dimensions and the construction of the primary base.

Some of the etch(es) employed in the method described above can result in formation of a facet and/or in formation of the sides of a ridge 32 of a waveguide 12. These surfaces are preferably smooth in order to reduce optical losses. Suitable etches for forming these surfaces include, but are not limited to, reactive ion etches, the Bosch process and the methods taught in U.S. patent application Ser. No. 09/690,959; filed on Oct. 16, 2000; entitled “Formation of a Smooth Vertical Surface on an Optical Component” and incorporated herein in its entirety and U.S. patent application Ser. No. 09/845,093; filed on Apr. 27, 2001; entitled “Formation of an Optical Component Having Smooth Sidewalls” and incorporated herein in its entirety.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. A method of forming an optical component, comprising:
forming a primary base on a component precursor having a light transmitting medium positioned adjacent to a preliminary base, a coefficient of thermal expansion (CTE) of the primary base being closer to a CTE of the light transmitting medium than a CTE of the preliminary base is to the CTE of the light transmitting medium; and
removing at least a portion of the preliminary base.

2. The method of claim 1, wherein removing at least a portion of the preliminary base includes removing substantially all of the preliminary base.

3. The method of claim 1, further comprising:
heating the component precursor after forming the primary base on the component precursor.

4. The method of claim 1, further comprising:
heating the component precursor to a temperature greater than 200° C. after forming the primary base on the component precursor.

5. The method of claim 1, further comprising:
cooling the component precursor after forming the primary base on the component precursor.

6. The method of claim 5, wherein the component precursor is cooled at a rate slower than 180° C./hour over a temperature range of at least 200° C.

7. The method of claim 5, further comprising heating the component precursor between forming the primary base on the component precursor and cooling the component.

8. The method of claim 1, wherein the primary base includes a medium selected from the group consisting of borosilicate glass, fused quartz and fused silica.

9. The method of claim 1, wherein the CTE of the primary base is within a range of the CTE of the light transmitting medium plus or minus three times the CTE of the light transmitting medium.

10. The method of claim 1, wherein the CTE of the primary base is within a range of the CTE of the light transmitting medium plus or minus the CTE of the light transmitting medium.

11. The method of claim 1, wherein the CTE of the primary base is within a range of the CTE of the light transmitting medium plus or minus one half the CTE of the light transmitting medium.

12. The method of claim 1, wherein the CTE of the primary base is within a range of the CTE of the light transmitting medium plus or minus two tenths the CTE of the light transmitting medium.

13. The method of claim 1, wherein the CTE of the primary base is within 1.5 ppm/° C. of the CTE of the light transmitting medium.

14. The method of claim 1, wherein the CTE of the primary base is within 0.5 ppm/° C. of the CTE of the light transmitting medium.

15. The method of claim 1, wherein the CTE of the primary base is within a range of the CTE of the light transmitting medium plus or minus two tenths the CTE of the light transmitting medium.

16. The method of claim 1, further comprising:
defining one or more waveguides in the light transmitting medium.

17. The method of claim 1, wherein the primary base includes one or more pockets.

18. The method of claim 17, further comprising:
forming one or more ridges in the light transmitting medium, at least one of the ridges being formed over a pocket.

19. The method of claim 1, wherein the primary base is formed on the component precursor such that the light transmitting medium is positioned between the primary base and the preliminary base.

20. The method of claim 1, wherein the primary base has a thickness greater than 200 μm.

21. The method of claim 1, wherein the primary base excludes a crystalline material.

22. A component precursor for formation of an optical component, comprising:
a light transmitting medium positioned between a primary base and a preliminary base; and,
a coefficient of thermal expansion (CTE) of the primary base is within a range of a CTE of the light transmitting medium plus or minus three times the CTE of the light transmitting medium.

23. The component precursor of claim 22, wherein the CTE of the primary base is within a range of the CTE of the light transmitting medium plus or minus twice times the CTE of the light transmitting medium.

24. The component precursor of claim 22, wherein the CTE of the primary base is within a range of the CTE of the light transmitting medium plus or minus the CTE of the light transmitting medium.

25. The component precursor of claim 22, wherein the CTE of the primary base is within a range of the CTE of the light transmitting medium plus or minus one half the CTE of the light transmitting medium.

26. The component precursor of claim 22, wherein the CTE of the preliminary base is outside of a range of the CTE of the light transmitting medium plus or minus the CTE of the light transmitting medium.

27. The component precursor of claim 22, wherein the CTE of the preliminary base is outside of a range of the CTE of the light transmitting medium plus or minus twice the CTE of the light transmitting medium.

28. The component precursor of claim 22, wherein the CTE of the preliminary base is outside of a range of the CTE of the light transmitting medium plus or minus times the CTE of the light transmitting medium.

29. The component precursor of claim 22, wherein the CTE of the primary base is within 1.5 ppm/° C. of the CTE of the light transmitting medium.

30. The component precursor of claim 22, wherein the CTE of the primary base is within 0.5 ppm/° C. of the CTE of the light transmitting medium.

31. The component precursor of claim 22, wherein the primary base excludes a crystalline material.

32. The component precursor of claim 22, wherein the primary base has a thickness greater than 200 μm and the preliminary base has a thickness greater than 200 μm.
